(19) United States
(12) Patent Application Publication
(10) Pub. No.: US 2003/0197713 A1
(43) Pub. Date: Oct. 23, 2003

(54) Motion image display device

(76) Inventor: Takao Yoguchi, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/384,615

(22) Filed: Mar. 11, 2003

Related U.S. Application Data
(60) Provisional application No. 60/363,100, filed on Mar. 12, 2002.

(51) Int. Cl. G09G 5/00

(52) U.S. Cl. 345/619

(57) ABSTRACT

An Motion Image Display Device, comprising a synthesized image sheet having an arrangement of a grid-form synthesized image generated based on four types of unit images and a mask sheet having an arrangement of a transparent section and a masking section regularly arranged so as to make only one type of original image visible correspondingly to the synthesized image comprising the grid-form unit images generated based on the four types of images, arranged over and spaced apart from the synthesized image sheet, wherein animation, a sentence, or colorful display variations are recognized with after images on a plane by means of the synthesized image made of four types of images.

This applicatin claims the benefit of U.S. Provisiona Application No. 60/363,100.

### BACKGROUND OF THE INVENTION

1. Field of the Invention

The present invention relates to a Display Device for realizing four types of image variations, and furthermore, a 4-framed animation by displaying a grid-form synthesized image generated based on four types of original images through an exclusive masking tool.

2. Related Background Art

Conventionally, there has been a display as shown in FIG. 29 as an example of an image variation method with prints or the like.

This display is made of a combination of a synthesized image AB and a masking tool 2₀ described later. Describing its principle and display, two types of original images shown in FIGS. 30A and 30B, namely, original images A₀ and B₀ are divided finely at regular intervals in an arbitrary direction as shown in FIGS. 31A and 31B to generate divided images a₀ and b₀. These are thinned out alternately as shown in FIGS. 32A and 32B to generate thinned-out images a₁₀ and b₁₀.

Next, these parts are rearranged to generate a synthesized image AB comprising zonal parts as shown in FIG. 33. Then, by superposing the masking tool 2₀ comprising zonal transparent sections and masking sections alternately arranged at the same intervals as the image division on this image, only one of the original images in the synthesized image is made visible as shown in FIGS. 34A and 34B.

Furthermore, by shifting the masking tool 2₀ appropriately, two types of image variations are generated with being displayed through the transparent sections. FIGS. 34A and 34B show these two types of display images A₀₁ and B₀₁ respectively.

In addition, as a principle of animation, there is conventionally known animation in which images gradually given variations in motion are flicked over in a form of a notebook.

The above methods, each having a very simple structure, are easy to implement. On the other hand, they have the following problems:

(a) The images are limited to two types and therefore lack in development and fun, thereby extremely limiting the range of applications.

(b) No continuous movement can be expressed due to only a two-image variation and therefore it is hard to use the method for animation; even if it is used, it serves little.

(c) Furthermore, its fun is reduced by half since the masking tool 2₀ must be moved.

(d) In the notebook-type method, the image is not flat and therefore a range of a viewer who can see the motion is limited when the motion is varied, by which the method is applicable only to a small range of uses.

### SUMMARY OF THE INVENTION

Therefore, the present invention is invented to solve these problems with keeping simplicity of the conventional methods so as to have wide availability.

In view of these problems, it is an object of the present invention to provide a Motion Image Display Device, comprising a synthesized image sheet 10 having an arrangement of a grid-form synthesized image E generated based on four types of unit images and a mask sheet having an arrangement of a transparent section and a masking section regularly arranged so as to make only one type of original image visible correspondingly to the synthesized image E comprising the grid-form unit images generated based on the four types of images, arranged spaced apart, wherein an image variation or a dynamic image variation is generated without moving the mask sheet.

In accordance with an aspect of the present invention, there is provided a Display Device making use of a characteristic that an arrangement of a mask sheet and a synthesized image sheet spaced apart enables a viewer to recognize animation, character, or pattern variations by means of huma Motions, focusing on that a walking person makes a parallel motion and an up-and-down motion.

Furthermore, in the Motion Image Display Device, the synthesized image sheet and the mask sheet may be arranged via a transparent member therebetween, thereby facilitating carrying or conveyance.

Preferably, in the Motion Image Display Device, a sheet Is provided with a folding section, a synthesized image sheet section, and a mask sheet section with the synthesized image sheet section arranged so as to be folded spaced apart from the mask sheet section in the folding section, thereby realizing easy fabrication, facilitating application to magazine insert supplement, and realizing easy transportation.

In the Motion Image Display Device, a sheet may be provided with a folding section to be a stand, a synthesized image sheet section, and a mask sheet section with the synthesized image sheet section arranged so as to be folded spaced apart from the mask sheet section in the folding section and to be stabilized by another folding section, thereby realizing easy fabrication.

Preferably, the Motion Image Display Device in which the synthesized image sheet and the mask sheet are arranged spaced apart is suspended from supporting members, thereby generating image variations utilizing shakes or vibrations.

The Motion Image Display Device in which the synthesized image sheet and the mask sheet are arranged spaced apart is supported by springs on a stand, thereby generating image variations utilizing huma Motions or vibrations.

### BRIEF DESCRIPTION OF THE DRAWINGS

FIGS. 1A, 1B, 1C and 1D show a basic principle in a Motion Image Display Device according to the present invention;

FIG. 2 is a side view of the Display Device in FIG. 1;

FIGS. 3A and 3B show a Motion Image Display Device according to an embodiment of the present invention;

FIGS. 4A and 4B show a Motion Image Display Device according to another embodiment of the present invention;

FIGS. 5A and 5B show a supporting state of a Motion Image Display Device according to an embodiment of the present invention;

FIG. 6 is a diagram showing a supporting state of a Motion Image Display Device according to another embodiment of the present invention;

FIG. 7 is a diagram showing a supporting state of a Motion Image Display Device according to still another embodiment of the present invention;

FIGS. 8A and 8B show a Motion Image Display Device according to another embodiment of the present invention;

FIG. 9 is a diagram showing a Motion Image Display Device according to still another embodiment of the present invention;

FIGS. 10A and 10B show a Motion Image Display Device according to another embodiment of the present invention;

FIG. 11 is a diagram showing a situation in which the Motion Image Display Device according to the embodiment of the present invention is applied to a shopwindow;

FIG. 12 is a diagram showing a situation in which the Motion Image Display Device according to the embodiment of the present invention is applied to a signboard on a road;

FIGS. 13A and 13B show a situation in which the Motion Image Display Device according to the embodiment of the present invention is applied to an outdoor advertisement;

FIG. 14A is a perspective view of a table lamp to which the present invention is applied; FIG. 14B is top plan view thereof; FIG. 14C is a side view thereof;

FIG. 15A shows a prism type table lamp according to the present invention; FIG. 15B shows a cylcindrical type table lamp according to the present invention; FIG. 15C show another example of a cylindrical type table lamp according to the present invention;

FIGS. 16A, 16B, 16C and 16D show four types of original images applied to the present invention;

FIGS. 17A, 17B, 17C and 17D shows images obtained by dividing the original images show in FIGS. 16A, 16B, 16C and 16D respectively;

FIGS. 18A, 18B, 18C and 18D shows images obtained by thinning out the images shown in FIGS. 17A, 17B, 17C and 17D respectively;

FIG. 19 is a plan view of a synthesized image E made of the images shown in Figs. FIGS. 18A, 18B, 18C and 18D;

FIG. 20 is a plan view of a display image A₀ viewed with an effect of a mask sheet according to the embodiment of the present invention;

FIG. 21 is a plan view of a display image B₀ viewed with an effect of the mask sheet in the Display Device according to the present invention;

FIG. 22 is a plan view of a display image C₀ viewed with an effect of the mask sheet in the Display Device according to the present invention;

FIG. 23 is a plan view of a display image D₀ viewed with an effect of the mask sheet in the Display Device according to the present invention;

FIG. 24 is a plan view of a display image at an intermediate point during motion between FIG. 20 and FIG. 21;

FIG. 25 is a plan view of a display image at an intermediate point during motion between FIG. 21 and FIG. 22;

FIG. 26 is a plan view of a display image at an intermediate point during motion between FIG. 22 and FIG. 23;

FIG. 27 is a plan view of a display image at an intermediate point during motion between FIG. 23 and FIG. 25;

FIG. 28 is a plan view of a display image at an intermediate point between the display image A₀₁, and the display image C₀₁ and also between the display image B₀₁ and the display image D₀₁;

FIG. 29 is a diagram showing a principle of a conventional Motion Image Display Device;

FIGS. 30A and 30B show images for a Display Device of assistance in explaining the conventional principle;

FIGS. 31A and 31B show images obtained by dividing the orginal images show in FIGS. 30A and 30B;

FIGS. 32A and 32B show images obtained by thinning oout the images shown in FIGS. 31A and 31B respectively;

FIG. 33 is a plan view of a synthesized image E made from the images shown in FIGS. 32A and 32B; and

FIGS. 34A and 34B show images displayed with a motion of the mask sheet.

### DETAILED DESCRIPTION OF THE PREFERRED EMBODIMENTS

The embodiments of the present invention will now be described hereinafter with reference to the accompanying drawings.

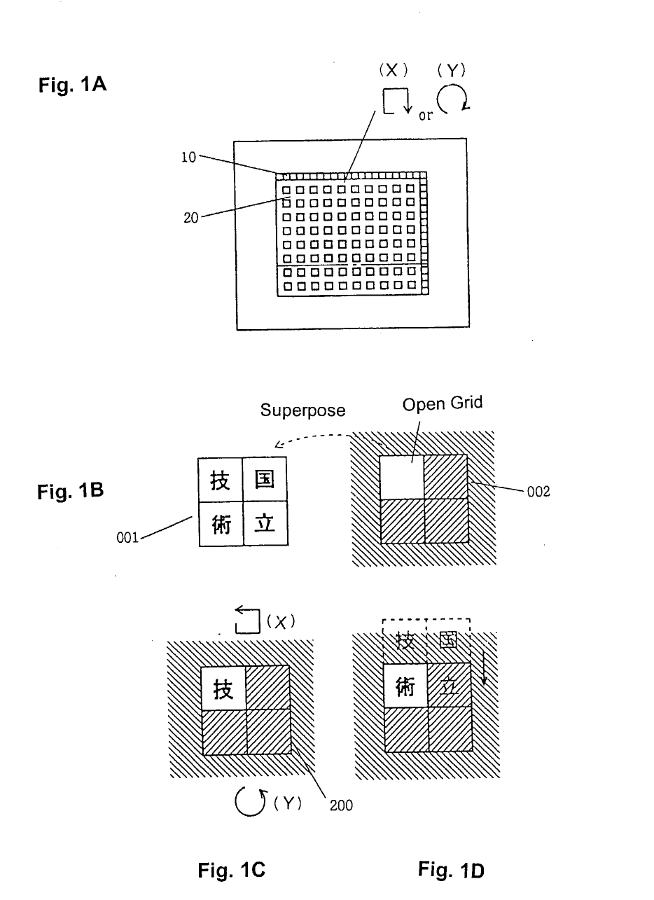

Referring to FIG. 1, there is shown a diagram of assistance in explaining a basic principle of a Motion Image Display Device according to the present invention and its plan view.

There is provided a mask sheet 20 having a transparent section and a masking section regularly arranged for visualizing only one type of original image, which is superposed on the top of the synthesized image sheet 10 having a grid-form synthesized image E generated based on four types of images.

With an effect of the mask sheet 20, only one type of original image in the synthesized image can be visualized. Therefore, with varying a 4-grid image as a unit image, four types of image variations are obtained by a circular motion or a quasi-circular motion of the mask sheet 20 as shown in FIG. 1.

At the top of FIG. 1A, there are shown an arrow x for a rectangular rotation and an arrow Y for a circular rotation of the mask sheet along the 4-grid unit image. A continuous image comprising four unit images is used and 4-framed animation is visualized as a display image.

With reference to FIGS. 1B, 1C and 1D, the principle is described, focusing on the minimum unit. If “JAPANESE CHARACTERS USED HERE” (a state established based on technologies) is written on a unit image 001 of the synthesized image, the unit mask sheet 002 is opened only by a quarter to visualize only one type of original image correspondingly to the unit image. Therefore, when the unit mask sheet 20 is moved sequentially in a direction indicated by the arrow (x) or (Y) in FIG. 1A, the characters of the unit image 001, “INSERT JAPANESE CHARACTERS HERE” appear as shown in FIGS. 1C and 1D.

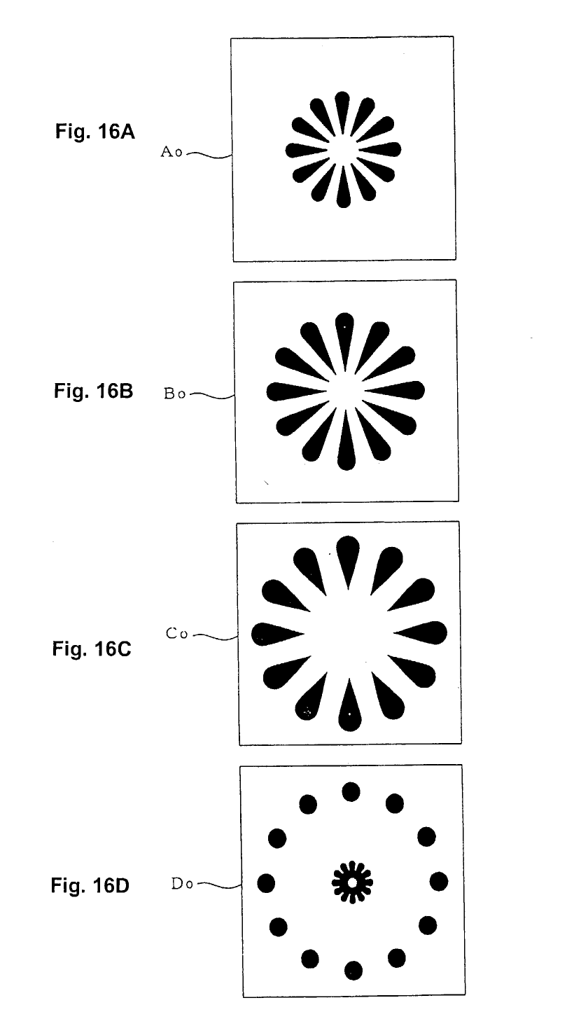

In other words, by superposing the sheet on the image as shown in FIGS. 1B, 1C and 1D and moving it in a rectangular form in units of a grid, the characters “INSERT JAPANESE CHARACTERS HERE” appear. Although a motion of kanji characters is treated in this example, images with a gradual motion like animation such as, for example, a firework opening out can be displayed by increasing the number of units as shown in FIGS. 16A, 16B, 16C and 16D and after.

In this case, a sequential appearance of the characters has been observed even if the unit mask sheet 002 is moved in a circular motion or a quasi-circular motion instead of a strict rectangular motion in units of a grid. Hereinafter, the principle will be described in detail.

According to the present invention, the unit image is treated as the minimum unit and the rotation is made passing all grids. Hereinafter, it will be described in further details.

While there is conventionally known animation made by flicking over images given gradual variations in a motion in a form of a notebook as a principle of this animation, the present invention realizes animation displayed on a planar surface.

As concrete images, illustration, photographs, characters, graphics, colors and the like are used.

A generation process of the grid-form synthesized image E arranged on the synthesized image sheet 10 will now be described hereinafter-in details by referring to drawings. In this example, a firework opening out is formed sequentially.

(a) First step: Prepare four types of original images having the same size, an original image A₀, an original image B₀ an original image C₀, and an original image D₀ (FIGS. 16A, 16B, 16C and 16D).

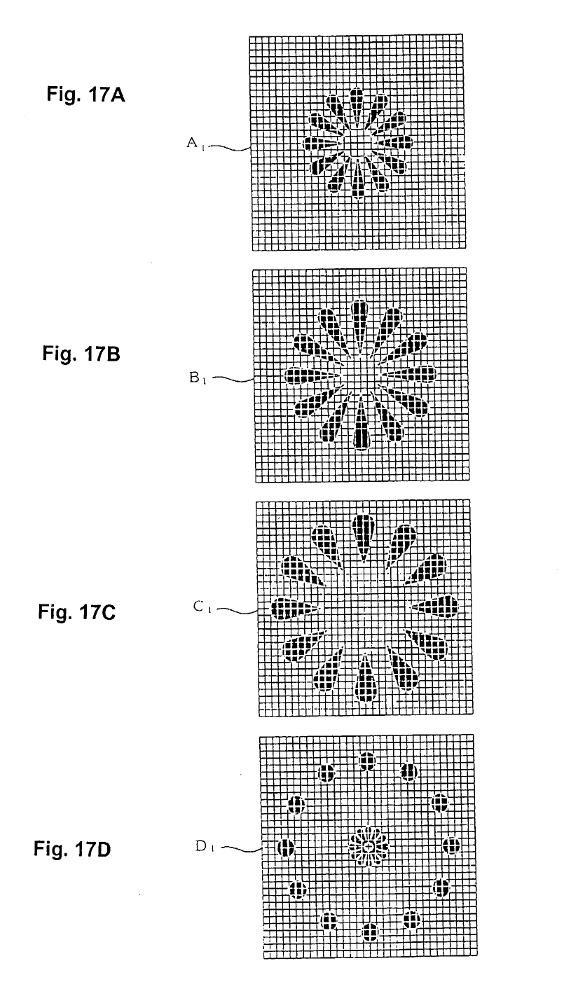

(b) Second step: Divide all the images into squares having the same horizontal and vertical size. Furthermore, divide the entire image by two grids in the horizontal and vertical directions so that a 4-grid unit is arranged in all directions (FIGS. 17A, 17B, 17C and 17D).

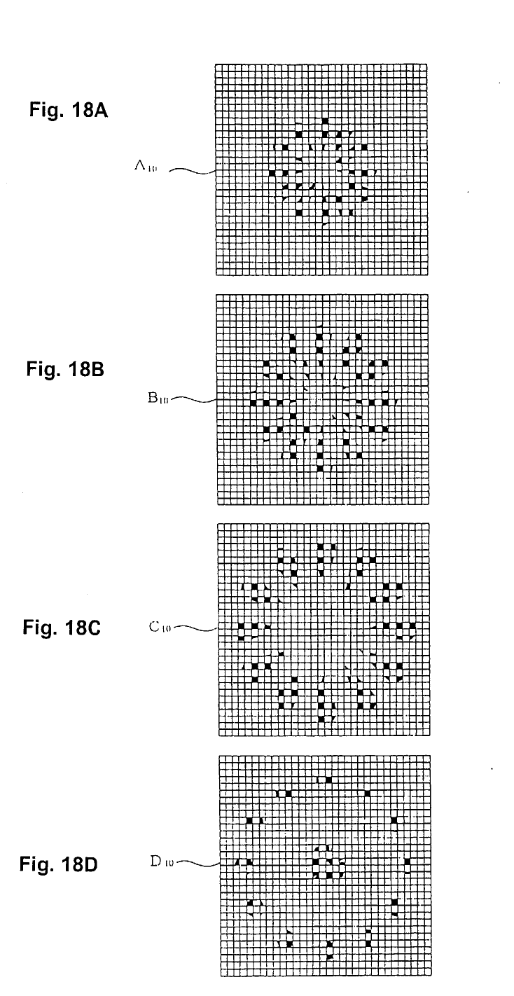

(c) Third step: In the unit of the divided image A₁ (FIGS. 17A, 17B, 17C and 17D), only an image in an upper left grid in the unit is left as it is and the images in other three grids are completely deleted. It is performed for all the units in the divided image A₁ (FIGS. 18A, 18B, 18C and 18D).

As a result, the divided image A₁, becomes a thinned-out image A₁₀ (FIG. 18A).

(d) Fourth step: In the divided image B₁ (FIG. 17B), only an image in an upper right grid in the unit is left and the Images in other three grids are completely deleted. It is performed for all the units in the divided image B₁ (FIG. 18B).

As a result, the divided image B₁, becomes a thinned-out image B₁₀ (FIG. 16B).

(e) Fifth step: In the divided image C₁ (FIG. 17C), only an image in a lower right grid in the unit is left and the Images in other three grids are completely deleted. It is performed for all the units in the divided image C₁, (FIG. 18C). As a result, the divided image C₁ becomes a thinned-out image C₁₀ (FIG. 18C).

(f) Sixth step: In the divided image D₁ (FIG. 17D), only an image in a lower left grid in the unit is left and the images in other three grids are completely deleted. It is performed for all the units in the divided image D₁ (FIG. 18D). As a result, the divided image D₁ becomes a thinned-out image D₁₀ (FIG. 18D).

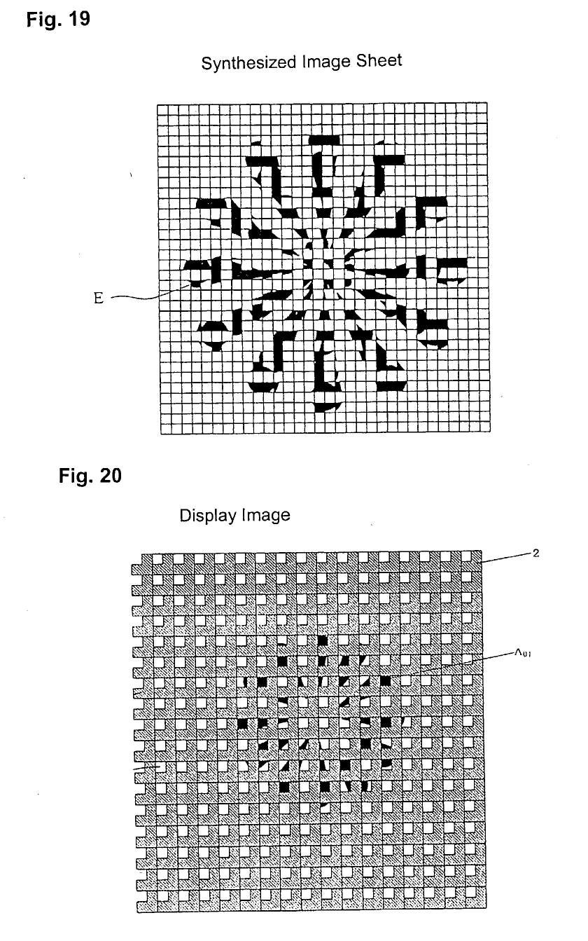

(g) By adding four types of the thinned-out images A₁₀, B₁₀ C₁₀, and D₁₀ obtained in the above processes together, a new synthesized image E is generated as shown in FIG. 19.

It will be understood that smaller and closer squares for generating the synthesized image are more effective to prevent degradation of the image quality caused by thinning out the images and therefore it is possible to obtain a favorable execution result.

FIGS. 1A, 1B, 1C and 1D show the basic principle of the mask sheet 20 in the Display Device 1 according to the present invention. A method of generating the mask sheet 20 is described below.

Corresponding to the 4-grid square that is a unit image used for generating the synthesized image on the synthesized image sheet 10 and using the unit image with an arbitrary transparent grid and other three masking grids as the minimum unit, the unit images are arranged in the horizontal and vertical directions by the required number to complete the mask sheet 20.

There are the following concrete methods; a method of obtaining a masking section by coating or impregnating process of a material having a masking property on a transparent resin film or the like and a method of obtaining a transparent section by boring an opaque material such as paper, wood, metal, resin or the like.

This mask sheet 20 is formed by the minimum units each having an arbitrary transparent grid and other three masking grids and therefore four types of images are sequentially displayed by moving the mask sheet 20 in order on the 4-grid squares on the synthesized image sheet 10 in a circular or quasi-circular motion by hand or the like.

The motion enables four types of images to be generated as a linguistically connected word sequentially and to be animation using after images.

Referring to FIG. 20, there is shown a relation between the mask sheet 20 and the synthesized image E.

It shows a condition that the mask sheet 20 is superposed on the synthesized image sheet 10 having the synthesized image E with the display image A₀₁ that is one of four types of display images appearing through the transparent sections.

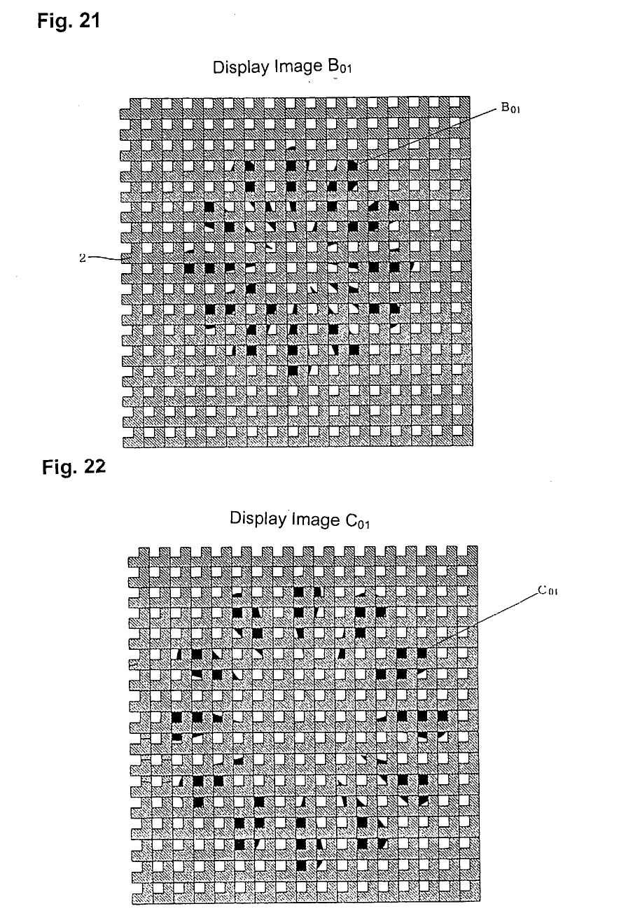

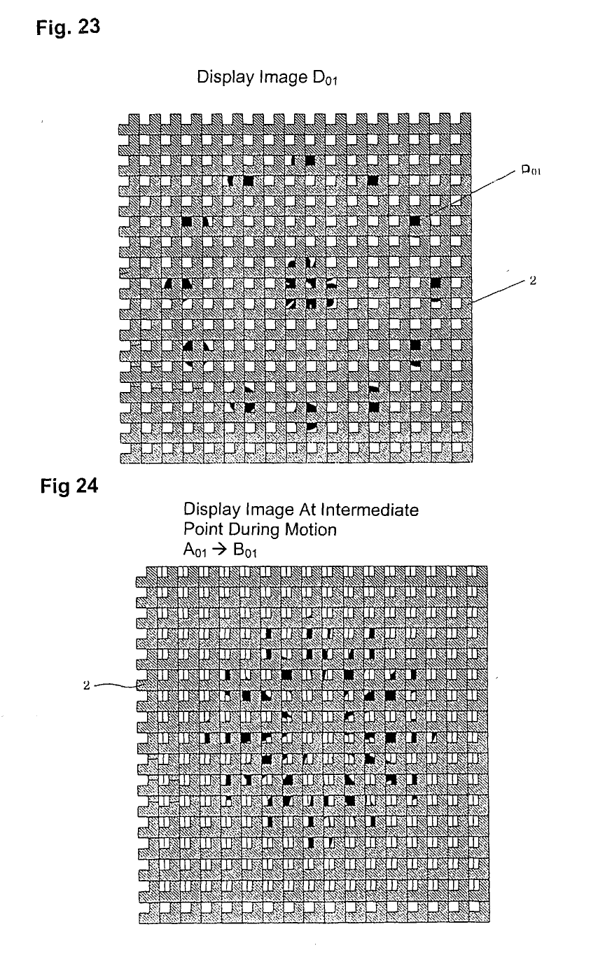

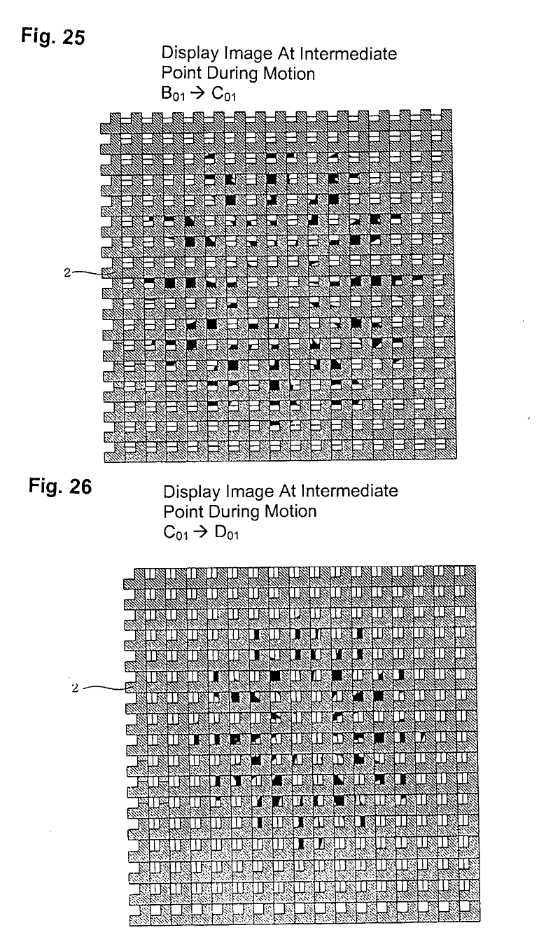

Subsequently, FIGS. 21, 22, and 23 show conditions that other three types of display images B₀₁, C₀₁ and D₀₁, appear with a motion of the mask sheet 20. Furthermore, FIGS. 24 to 26 show display images at intermediate points during a motion between images.

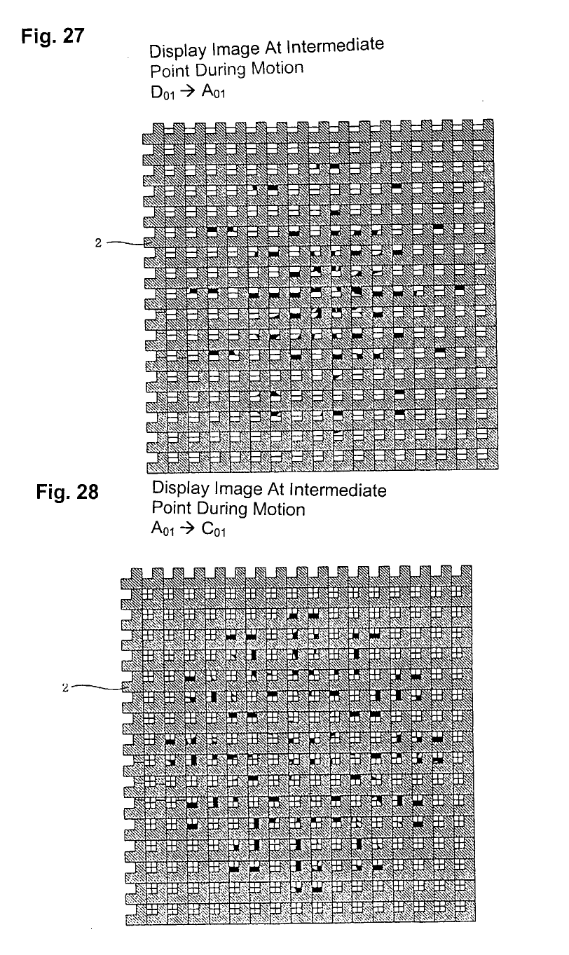

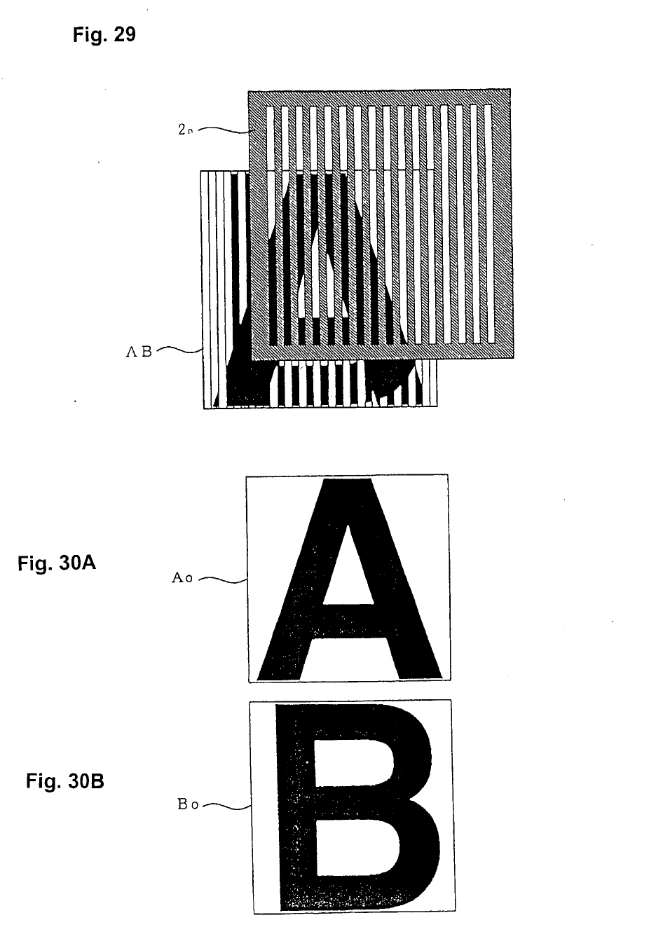

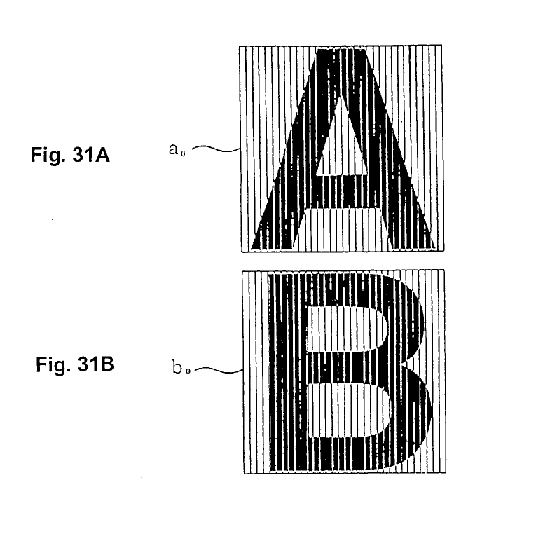

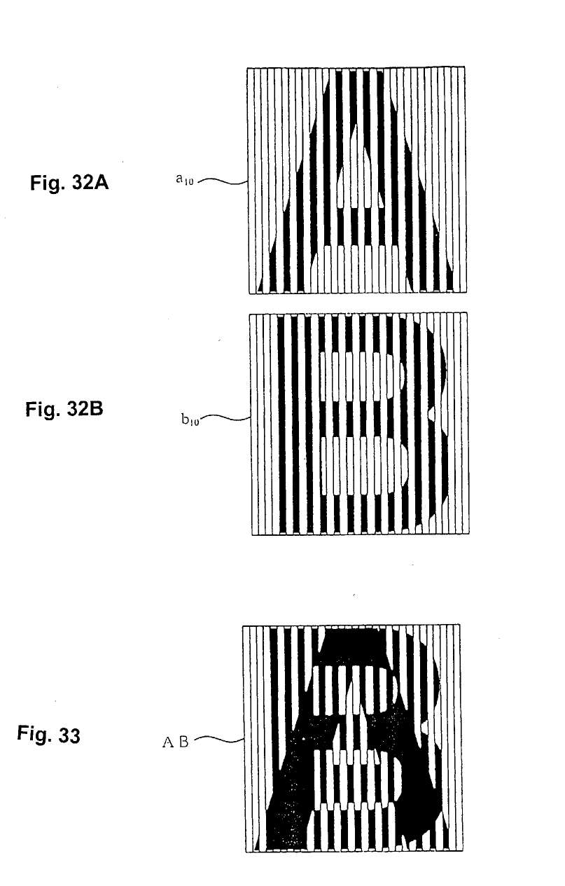

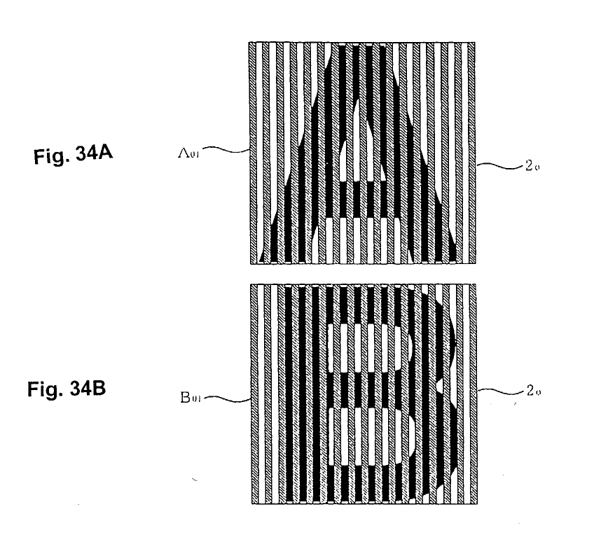

FIGS. 24, 25, 26, and 27 show a display image at an intermediate point during a motion between the display image A₀₁, and the display image B₀₁, between the display image B₀₁, and the display image C₀₁, between the display image C₀₁ and the display image D₀₁, and between the display image D₀₁, and the display image A₀₁, respectively.

FIG. 26 shows a display image at an intermediate point between the display image A₀₁ and the display image C₀₁ and also at an intermediate point between the display image B₀₁ and the display image D₀₁.

The above display images A₀₁ to D₀₁ show a process of a firework opening outward and therefore a scene of an opening firework can be displayed.

According to the principle described hereinabove, the present invention is intended for recognition of animation, character, and further pattern variations by superposing the mask sheet 20 on the synthesized image sheet 10. The present invention is intended for the effect of the image variation 14 or animation without moving the mask sheet 20 as shown in FIG. 1 with an application of this principle.

In other words, as a result of an experiment with an arrangement of the synthesized image sheet 10 and the mask sheet 20 spaced apart, it is found that a person moves with adjusting and finding out the screen with a circular motion on demand corresponding to or in response to variations since he or she moves in a parallel motion and a up-and-down motion and therefore his or her motion is similar to the circular or quasi-circular motion, by which he or she can recognize the above variations and the person has a learning ability while identifying the screen prompted by an interest or curiosity in an object and has an adjustment ability. Additionally, it is observed that the finding prompts interests further.

Therefore, in this invention, it is found that a user him/herself can recognize the screen without a motion of the mask sheet 20 on the synthesized image sheet 10.

It is because the user adjusts the screen by him/herself until he or she can see the displayed image.

Accordingly, in the above embodiment, there is shown a scene that the firework opens out and a sequential motion causes the images to look like a firework which has been set off is opening due to after image effects.

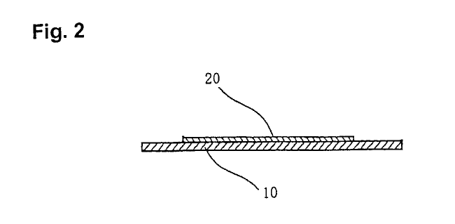

Referring to FIG. 2, there is shown an embodiment of a combination of the synthesized image sheet 10 and the mask sheet 20, While an object is animation in this embodiment and it may be a firework as set forth in the above, naturally it is possible to display a motion of a boy tossing balls sequentially like playing with beanbags or an elephant moving legs in the same principle.

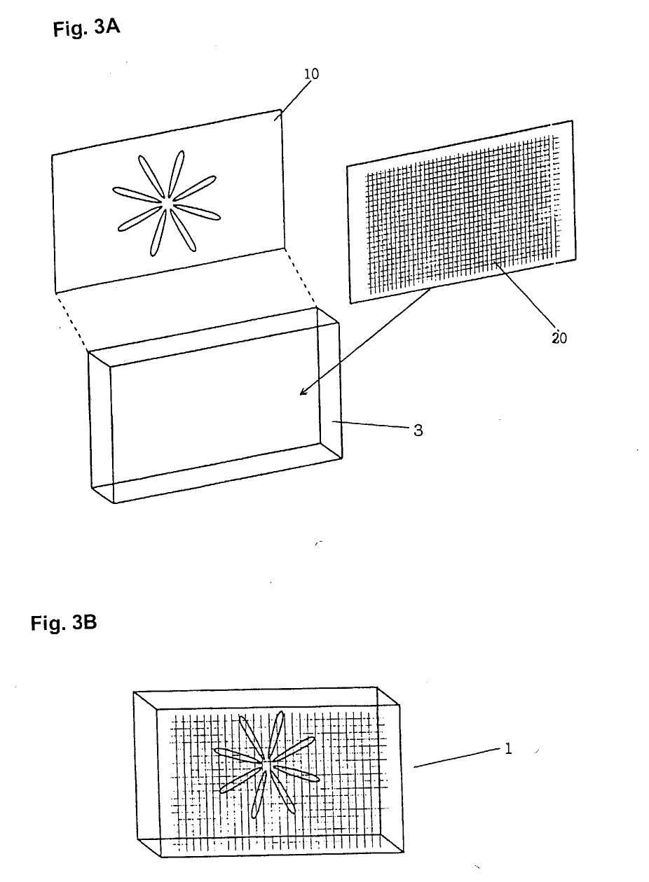

Referring to FIGS. 3A abd 3B, there is shown a diagram in which the synthesized image sheet 10 is spread on the rear surface of a rectangular member 3 made of transparent acrylic resin and the mask sheet 20 is pasted on the front surface thereof by means of an appropriate adhesive.

While this configuration is applicable to an appropriate Display Device 1, a man passing by the Display Device 1 recognizes an animation phenomenon or a variation of a character or a pattern.

If it is put on a disk or at a shopwindow of a store, it can be a Display Device drawing public attention.

In this example, the rectangular member 3 functions as a member providing a space between the synthesized image sheet 10 and the mask sheet 20, while it has an effect that a viewer of the Display Device 1 seeks a mechanism of the animation, character, or pattern variations in the transparent rectangular member 3, has doubts, makes a study, and is further interested in it.

As a reason for the above, a motion of a person includes not only a parallel motion, but also an up-and-down motion and therefore it becomes a circular motion or a quasi-circular motion, by which the person can recognize four types of variations without a motion of the mask sheet 20.

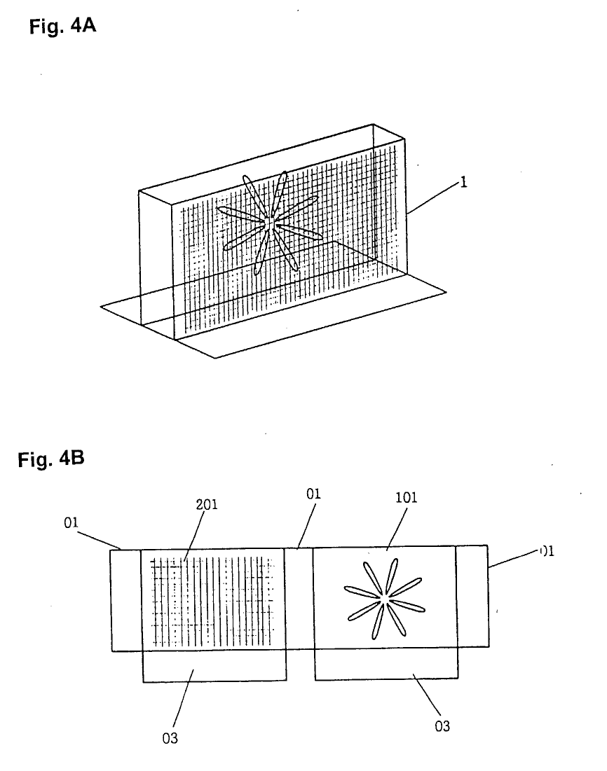

Referring to FIGS. 4A and 4B, there is shown an embodiment that can be formed by a sheet. As shown in FIG. 4B, the sheet is previously provided with folding sections 01, 01, 01, a synthesized image sheet section 101, a mask sheet section 201, and stand sections as a stand 03, 03. Then, they are folded sequentially in advance, the folding sections 01, 01 at both ends of the mask sheet section 201 and the synthesized image sheet section 101 are bonded by appropriate bonding agent, and the stand sections 03, 03 are raised for a formation.

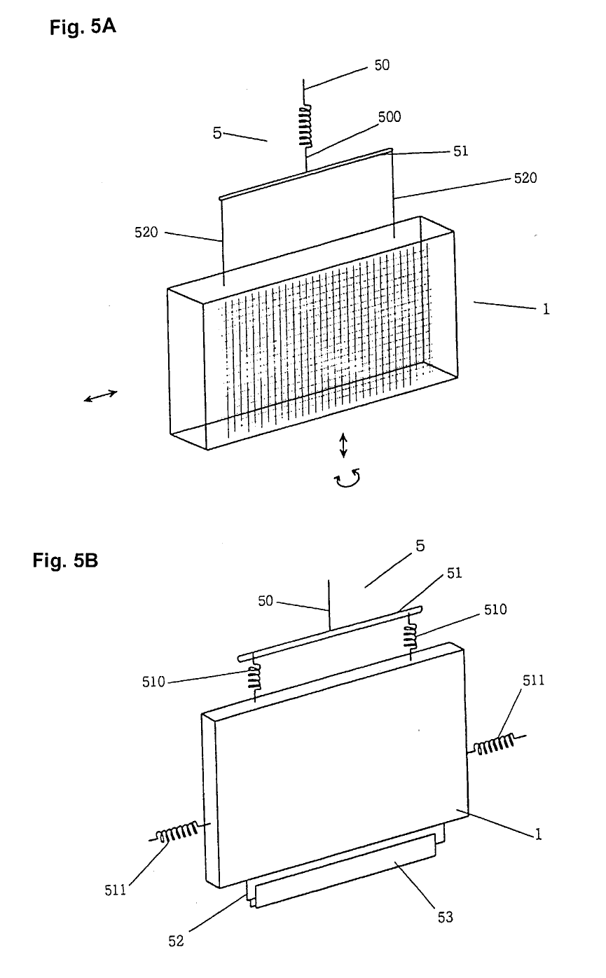

Referring to FIG. 5A, there is shown an embodiment in which the Display Device 1 is suspended from a ceiling or the like by using a string member 5 instead of putting the Display Device 1 on a disk or the like.

In this embodiment, although the Display Device 1 may have an interesting motion like a rotation with wind or the like simply by a suspension, the Display Device 1 is suspended at the both ends thereof with strings 520, 520 from a bar 51 and the bar 51 is suspended by a string 50 as the string member 5 as shown in FIG. 5A.

The string 50 is arranged with a spring 500 interposed and therefore the Display Device 1 includes motions of a rotation in a horizontal direction, a swing of the pendulum, and an up-and-down motion, by which a person passing by the Display Device 1 easily finds out a motion of animation or character variations advantageously.

FIG. 5B shows an embodiment in which a rotation in the horizontal direction is prevented so that the motions are limited to the swing of the pendulum in the horizontal direction and the up-and-down-motion.

As the string member 5, a bar 51 is suspended by a string 50 and the Display Device 1 is suspended by springs 510, 510 under the bar 51.

The Display Device 1 has springs 511, 511 in the both sides to maintain and adjust the swing of the pendulum. There is provided a guide member 520 at the bottom of the Display Device 1. At the bottom of the Display Device 1, the guide member 520 moves inside the supporting member 53 arranged on a fixed surface of the Display Device 1 and therefore the Display Device 1 is prevented from rotating in the horizontal direction. Accordingly, the motions are limited to the up-and-down motion and the motion in the horizontal direction.

Therefore, apparently the motion approximates to a quasi-circular motion.

While there may be various other supporting methods for supporting the is Display, Device 1, it is apparent that various supporting methods are applicable based on the technical idea according to the present invention by those skilled in the art in combinations of motions vertical and horizontal directions.

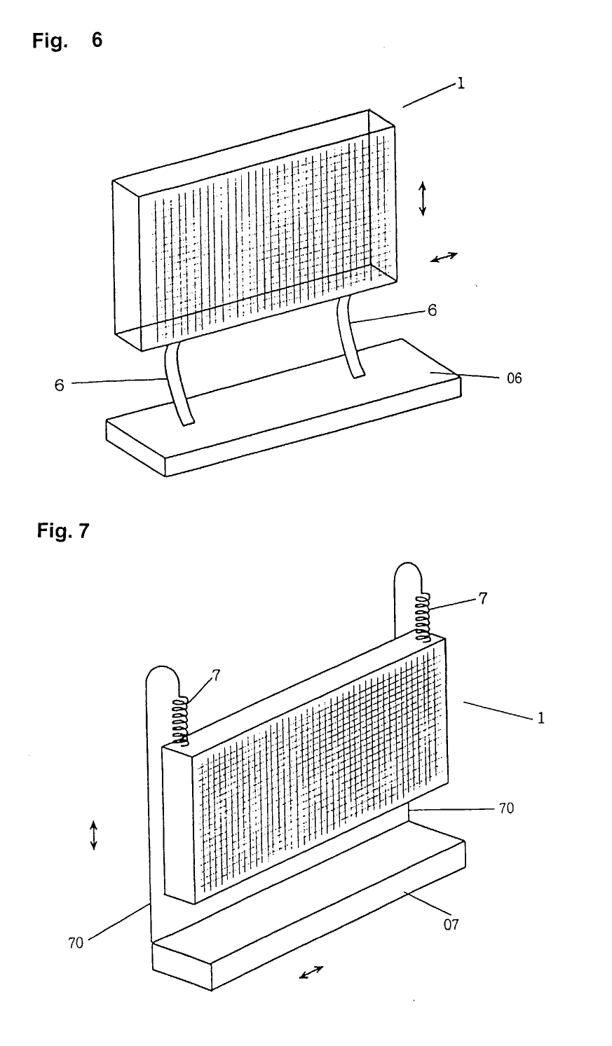

Referring to FIG. 6, there is shown another embodiment in which the Display Device 1 is supported with an elastic material.

The supporting material shown in FIG. 6 comprises leaf spring supporting members 6, 6 for supporting at a lower section arranged on a stand 06.

Referring to FIG. 7, there is shown a Display Device suspended from above by supporting bars 70, 70 with springs 7, 7, with the supporting bars 70, 70 fixed to a stand 07.

In this case, the Display Device I itself vibrates due to vibrations of a person, an automobile, or the like, thereby promoting causing animating effects or character pattern variations.

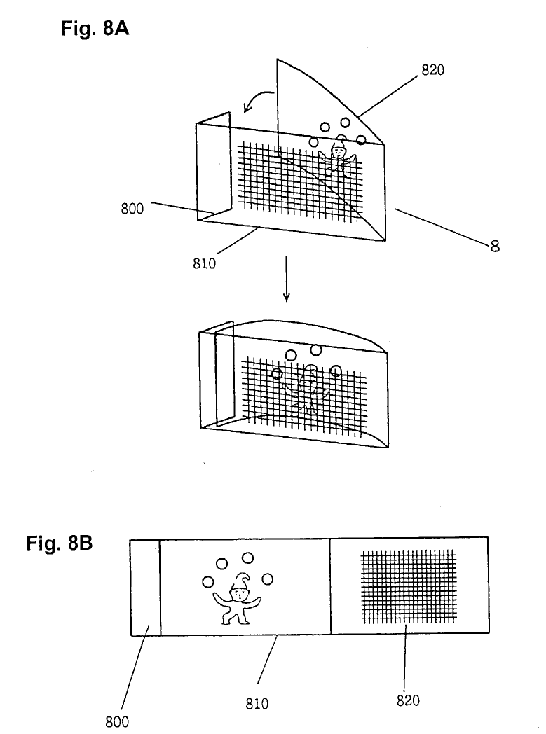

As shown in FIGS. 8A and 8B, a sheet is previously provided with a folding section 800, a synthesized image sheet section 810, and a mask sheet section 820. Then, the mask sheet section 820 is folded and caught by the folding section 800 with being spaced apart from the synthesized image sheet section 810 for fabrication as shown in FIGS. 8A and 8B.

Also in this embodiment, a person senses and reacts to the motion of the Display Device and learns to confirm the reaction by him/herself and the Display Device makes a circular motion or a quasi-circular motion by itself, thereby causing more advertisement effects.

While this embodiment can be easily manufactured, it is possible not only to put it on a desk, but to suspend it from above as shown in FIG. 5 and FIG. 7 to make it rotate or vibrate appropriately with a wind or the like so that it is displayed to walking people.

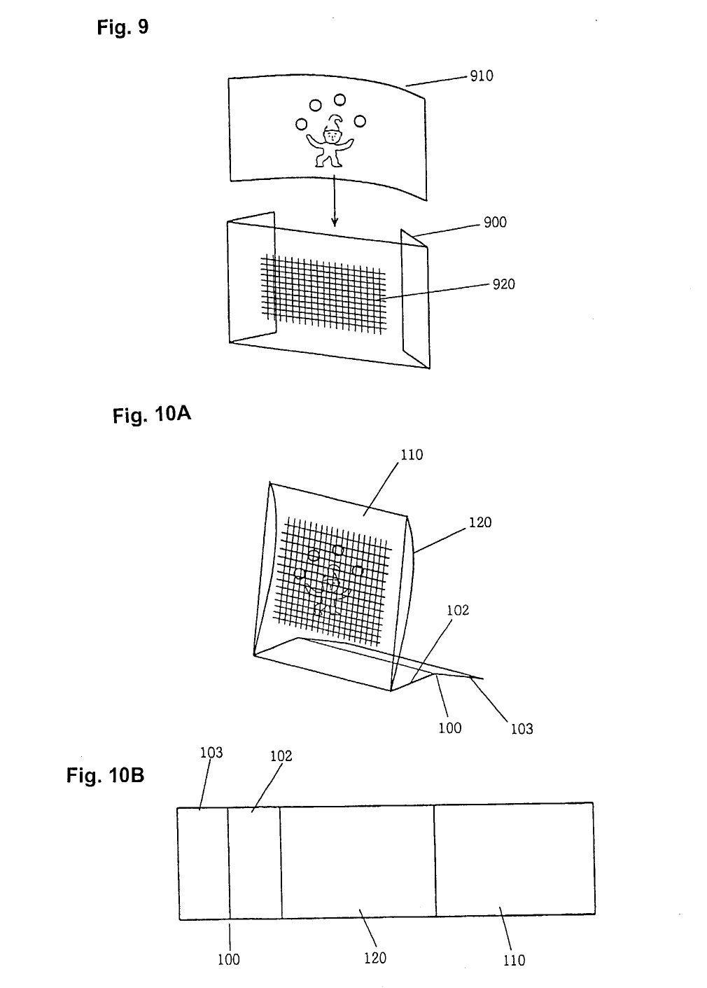

Referring to FIG. 9, there is shown a foldable Display Device 1 according to another embodiment, which is completed by fabrication.

In other words, as shown in FIG. 9, a sheet is provided with folding sections 900, 900 at both ends of the mask sheet section 910 and a synthesized image sheet section 920 is inserted into the folding sections 900, 900.

Naturally, the synthesized image sheet section 910 is longer than the mask sheet section 910 and therefore the synthesized image sheet section 920 arches when it is inserted, thereby generating a required space.

Referring to FIGS. 10A and 10B, there is shown still another embodiment of a vertical Display Device put on a desk or the like which is equivalent to the embodiment shown in FIG. 8 which is erected, similarly in that variations are recognized by a huma Motion.

It is a foldable Display Device 1, which is completed by fabrication from a sheet shown in FIG. 10B.

In other words, as shown in FIG. 10B, the sheet is provided with folding sections 102 and 103 to be a stand section 100 at one end of a mask sheet section 120.

The folding sections 102 and 103 are folded in chevron so as to function as a stand as shown in FIG. 10A and the folding section 102 is folded so as to have such a relation with the synthesized image sheet section 110 that the mask sheet section 120 can be inserted-therebetween.

Then, the synthesized image sheet section 110 is folded and inserted into a section between the stand section 100 and the mask sheet section 120. As shown in FIG. 10A, it is put between them for fabrication.

For the fixing, it is also possible to arrange an appropriate cutup section for insertion or to use an appropriate adhesive or cellophane tape.

After completing the fabrication, it can be erected like a stand on a desk or the like directly.

Naturally, the synthesized image sheet section 110 is longer than the mask sheet section 201 and therefore the synthesized image sheet section 110 arches, thereby generating a required space between them.

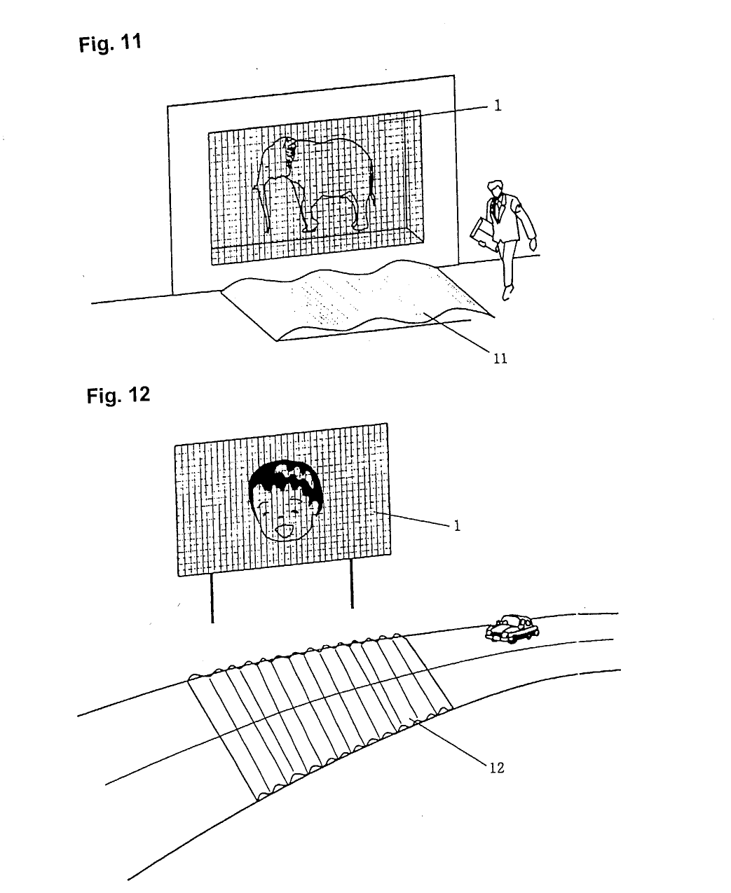

Referring to FIG. 11, there is shown an embodiment in which a Display Device 1 is installed at a shopwindow of a department store or the like on the basis of the same principle. In this diagram, an elephant is illustrated with settings of moving legs. A lot of people pass there and therefore passersby are aware of variations of the shop window, thereby generating outstanding effects.

In addition, to have a further effect, an up-and-down slope material 11 may be previously arranged on a road surface so as to cause a circular motion phenomenon whenever an automobile passes it, thereby making it more interesting.

Referring to FIG. 12, there is shown an embodiment in which the Display Device is arranged in the outdoors such as along a driveway. When an, automobile passes it, the automobile itself makes an up-and-down motion and therefore it also causes animation, character, or pattern variations in this case, too.

Particularly, this phenomenon may often occur on a rugged road surface.

There is a waved section 12 as a road section for a cure for drowsiness at the end of an express highway. At this point, an up-and-down motion will occur and the Display Device will demonstrate its effect further.

In any case, a fellow passenger or an automobile itself slightly moves up and down in a vehicle and therefore he or she finds out its motion or variation by him/herself, by which the Display Device according to the present invention will have a further effect.

Naturally, the Display Device can be installed alongside a railroad line for trains or locomotives as well as automobiles; it is very effective along a railroad line for commuter trains.

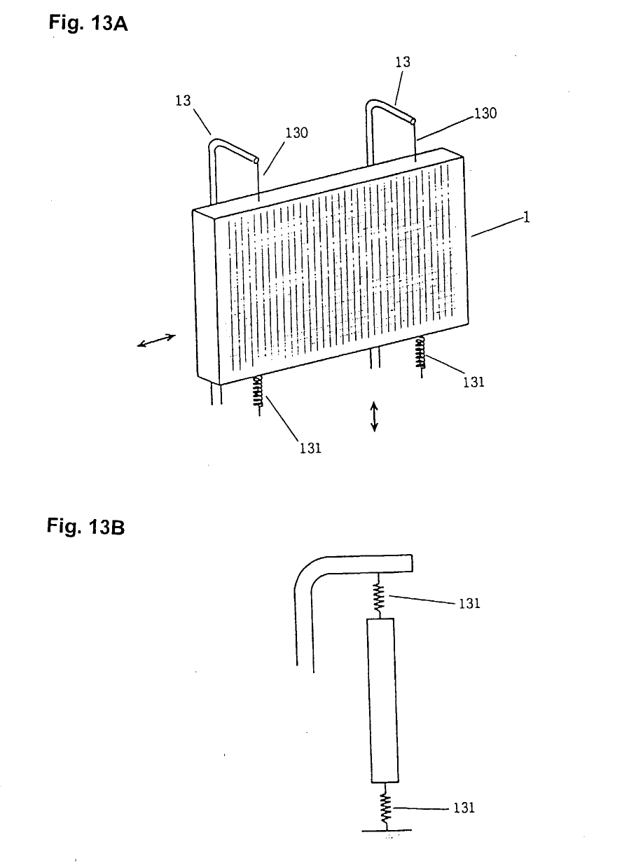

Referring to FIGS. 13A and 13B, there is shown an embodiment of vibrating a Display Device 1 as an advertising display in FIG. 12 by utilizing vibrations of wind or an automobile so as to promote animating or variations of characters or patterns.

The Display Device 1 is suspended by ropes 130, 130 as shown in FIG. 13 with supporting members 13, 13 and is fixed at the bottom via springs 131, 131.

It is suspended by the rope-130 at an upper portion so 22 that it is easy to move in a horizontal direction and is connected to the spring 131 at the bottom. In any case, it is understood that the Display Device is supported so that it can make a horizontal motion as well as an up-and-down motion.

Naturally, it is possible to use ropes instead of springs at the bottom, too.

In the embodiment shown in FIG. 13B, springs 131, 131 are used to support the Display Device 1 at the upper portion and at the bottom.

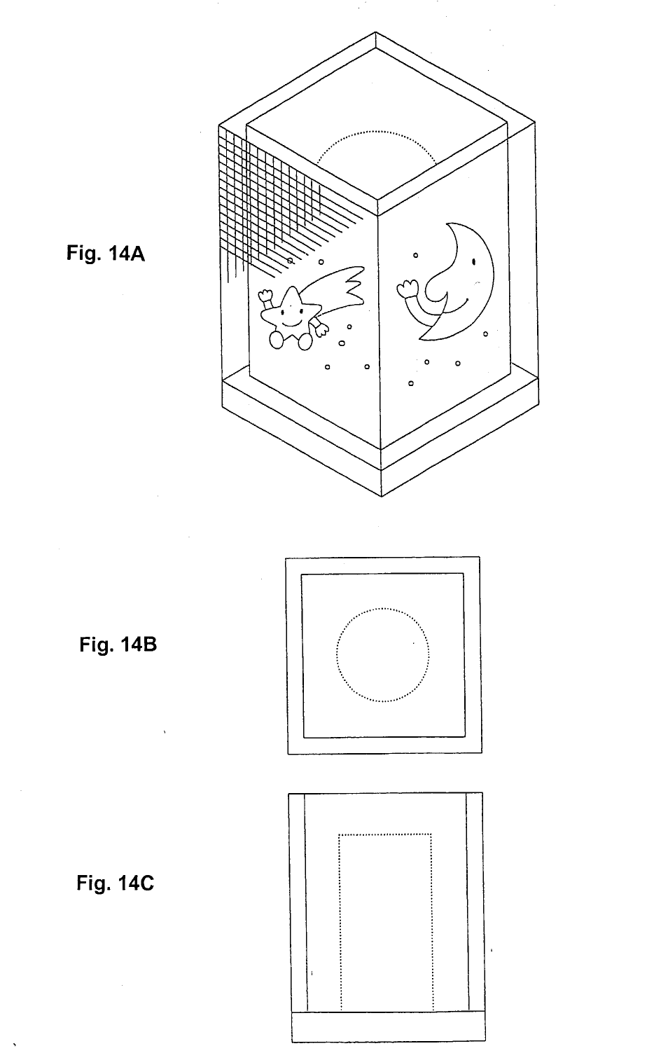

Another embodiment according to the present invention is shown in FIGS. 14A, 14B and 14C. FIG. 14A is a perspective view of a quadratic prism table lamp to which a motion image display device is applied. FIG. 14B is a top plan view thereof. FIG. 14C is a front elevational view thereof.

In the quadratic prism table lamp, a mask sheet 250 surrounds the table lamp. A synthesized image sheet is provided inside the mask sheet 250 and corresponds to the mask sheet 250. An electric bulb 8 is provided inside the mask sheet 250. Since light from the electric bulb sufficiently comes through the synthesized image sheet, a synthesized image can be seen from outside. Therefore, motion effects by the motion image display device is sufficiently recognized.

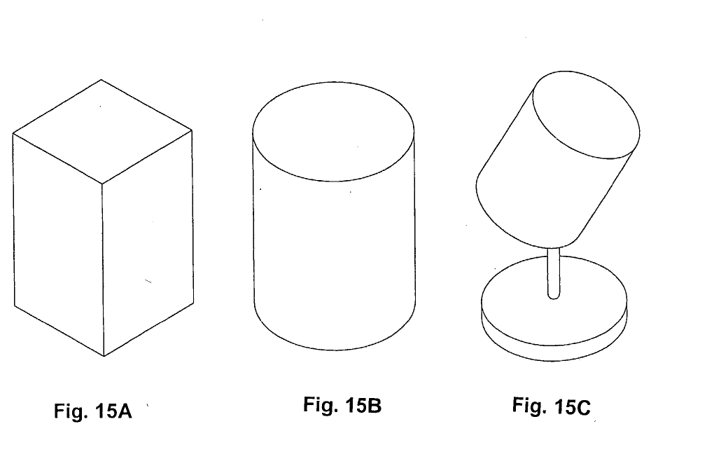

The shape of the table lamp or the mask sheet is not limited to a quadratic prism as shown in FIGS. 14A, 14B, 14C and 15A. It can be any shape such as a cylinder or oval prism as shown in FIGS. 15B and 15C.

As set forth hereinabove, the Display Device with the synthesized image sheet 10 and the mask sheet 20 integrated has a capability of enabling a viewer to recognize an animating phenomenon or character or pattern variations only by being installed.

While animations are used for the descriptions in the above embodiments, naturally a character array having a static meaning may be used. For example, if a character array such as “Insert Japanese Text here” (Giants has won the championship) is used, the character array can be displayed by a rectangular or circular motion and therefore it becomes more interesting, by which various displays are enabled by using four types of variations.

In addition, if various patterns are arranged, a flowery variation like a kaleidoscope can be displayed. It will be apparent to those skilled in the art that the principle of the present invention is applicable to several Display Devices.

As set forth hereinabove, the present invention has various effects as described below.

The Motion Image Display Device according to the present invention has four types of variations of an image reproduced on the Display Device in spite of a simple structure only by being installed, is promising in development due to abundant information types, is capable of displaying a word or a phrase such as a Chinese compound word made of four characters having a train of meanings or a message, and further has various displaying effects such as lively-style illustrations having turn and conclusion or colorful expressions. In addition, by using four types of smooth image variations and a synthesized image made of four continuous images, interesting displays are enabled only by installing the Display Device with displaying smooth animation or an image display of seamless cyclic animation image display in combination with an effect of visual residual images.

Furthermore, the Motion Image Display Device according to the present invention is installed only for use and therefore only a change of the Display Device in its structure or materials increases the range of uses, thereby providing vision transmission effects such as pleasures or surprises, which have not been conventionally achieved.

As concrete uses or fields of use, there are assumed writing materials, toys, educational materials, publication, advertisement, showpieces, advertising displays, and the like; by using it for a medium widely requiring a vision transmission effect, an intensive and impressive effect is expected. In addition, it need be only installed and therefore it has a wide range of applications.

Furthermore, in the present invention, only by installing the Motion Image Display Device, a viewer of the Display Device learns animation or character, pattern, color variations with studying and checking the Display Device by him/herself since human beings inherently are interested in unknown things and therefore the viewer recognizes the motion or characters with much interest in it, by which the Display Device does not need any particular movable apparatus advantageously.

The disclosure of Japanese Patent Application No. 2000-275332 filed Sep. 11, 2000 including specification, drawings and claims is incorporated herein by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. A motion image display device comprising:
a synthesized image sheet having an arrangement of a grid-form synthesized image generated based on four types of unit images and;
a mask sheet having an arrangement of a transparent section and a masking section regularly arranged so as to make only one type of original image visible correspondingly to the synthesized image comprising the grid-form unit images generated based on the four types of images, arranged spaced apart.

2. The motion image display device according to claim 1, wherein said synthesized image sheet and said mask sheet are arranged via a transparent member therebetween.

3. The motion image display device according to claim 1, wherein a sheet is provided with a folding section, a synthesized image sheet section, and a mask sheet section with the synthesized image sheet section arranged so as to be folded spaced apart from the mask sheet section in the folding section.

4. The motion image display device according to claim 1, wherein a sheet is provided with a folding section to be a stand, a synthesized image sheet section, and a mask sheet section with the synthesized image sheet section arranged so as to be folded spaced apart from the mask sheet section in the folding section and to be stabilized by another folding section.

5. The motion image display device according to claim 1, wherein said motion image display device with said synthesized image sheet and said mask sheet arranged spaced apart is suspended from supporting members.

6. The motion image display device according to claim 1, wherein said motion image display device with said synthesized image sheet and said mask sheet arranged spaced apart is supported by springs on a stand.
